(19) United States
(12) Patent Application Publication
(10) Pub. No.: US 2026/0081504 A1
(43) Pub. Date: Mar. 19, 2026

(54) ELECTRIC MACHINE HAVING NOTCHED MAGNETS AND INTEGRATED COOLING

(71) Applicant: Hamilton Sundstrand Corporation, Charlotte, NC (US)

(72) Inventors: Andrzej E. Kuczek, Bristol, CT (US); Jagadeesh K. Tangudu, South Windsor, CT (US)

(21) Appl. No.: 19/373,137

(22) Filed: Oct. 29, 2025

Related U.S. Application Data
(63) Continuation-in-part of application No. 17/989,277, filed on Nov. 17, 2022.

(51) Int. Cl. H02K 9/22; B64D 33/08; B64D 41/00; H02K 1/2798; H02K 1/30; H02K 7/116; H02K 9/20; H02K 11/33; H02K 21/24

(52) U.S. Cl. CPC H02K 9/225; B64D 33/08; B64D 41/00; H02K 1/2798; H02K 1/30; H02K 7/116; H02K 9/20; H02K 11/33; H02K 21/24; B64D 2221/00

(57) ABSTRACT

Aircraft and aircraft electric motors include a rotor assembly having a plurality of magnets arranged in magnet Halbach arrays on a magnet support. The magnet support includes a plurality of protrusions defined on surface thereof and each magnet Halbach array includes a respective cut-out notch configured to engage with a respective protrusion. An output shaft is operably coupled to the rotor assembly. A stator having a support structure and at least one winding wrapped about a plurality of stator teeth is configured to generate an electromagnetic field to cause rotation of the rotor assembly. A heat pipe is arranged within each protrusion and configured to transfer heat away from the magnets.

### CROSS-REFERENCE TO RELATED APPLICATIONS

This application is a Continuation-in-Part Application of U.S. patent application Ser. No. 17/989,277, filed Nov. 17, 2022, the disclosure of which is incorporated herein by reference in its entirety.

### STATEMENT REGARDING FEDERALLY SPONSORED RESEARCH OR DEVELOPMENT

This invention was made with government support under Contract No. DE-AR0001351 awarded by the U.S. Department of Energy. The government has certain rights in the invention.

### BACKGROUND

The present disclosure relates to electric motors, and more particularly, to electric motor assemblies with high efficiency and power density having relatively low weight for aircraft applications.

Traditional electric motors may include a stator and a rotor, with electrical motor windings in the stator that, when energized, drive rotation of the rotor about a central axis. Permanent magnet motors are widely used for high power density and efficient applications in aviation industry. The high torque density can be achieved by maximizing the magnetic loading through implementation of the Halbach array permanent magnet rotor structure; however, the dense permanent magnets can be a major barrier when minimizing the weight of the application. Accordingly, improved electric motor components may be used to improve the weight of such electric motors while also provide additional benefits, such as improved power density and the like.

### BRIEF DESCRIPTION

According to some embodiments, aircraft electric motors are provided. The aircraft electric motors include a rotor assembly comprising a plurality of magnets arranged in magnet Halbach arrays on a magnet support, wherein the magnet support comprising a plurality of protrusions defined on surface thereof and each magnet Halbach array comprises a respective cut-out notch configured to engage with a respective protrusion, an output shaft operably coupled to the rotor assembly, a stator comprising a support structure and at least one winding wrapped about a plurality of stator teeth, the stator configured to generate an electromagnetic field to cause rotation of the rotor assembly, and a heat pipe arranged within each protrusion of the plurality of protrusions, the heat pipe configured to transfer heat away from the magnets.

In addition to one or more of the features described herein, or as an alternative, further embodiments of the aircraft electric motors may include that the notch is formed in at least one center magnet of each magnet Halbach array.

In addition to one or more of the features described herein, or as an alternative, further embodiments of the aircraft electric motors may include that the notch is formed between two split-magnets at ends of adjacent magnet Halbach arrays.

In addition to one or more of the features described herein, or as an alternative, further embodiments of the aircraft electric motors may include that each heat pipe comprises a forward heat pipe section and an aft heat pipe section arranged between a forward end face and an aft end face of the magnet support.

In addition to one or more of the features described herein, or as an alternative, further embodiments of the aircraft electric motors may include that the forward heat pipe section is circumferentially offset from the aft heat pipe section.

In addition to one or more of the features described herein, or as an alternative, further embodiments of the aircraft electric motors may include that the magnet support defines a forward end face and an aft end face and wherein the forward heat pipe section is angled radially inward in a direction from an inflection point between the forward end face and the aft end face to the forward end face and the aft heat pipe section is angled radially inward in a direction from the inflection point to the aft end face.

In addition to one or more of the features described herein, or as an alternative, further embodiments of the aircraft electric motors may include a binder between the two split-magnets to secure the two split-magnets together.

In addition to one or more of the features described herein, or as an alternative, further embodiments of the aircraft electric motors may include a binder applied to the magnets to secure the magnets together and to the magnet support.

In addition to one or more of the features described herein, or as an alternative, further embodiments of the aircraft electric motors may include that the binder comprises an epoxy material.

In addition to one or more of the features described herein, or as an alternative, further embodiments of the aircraft electric motors may include a rotor wrap arranged about the magnet support and configured to structurally support the magnet support.

In addition to one or more of the features described herein, or as an alternative, further embodiments of the aircraft electric motors may include that the rotor assembly includes an outer rotor and an inner rotor, wherein the stator is arranged radially between the inner rotor and the outer rotor.

In addition to one or more of the features described herein, or as an alternative, further embodiments of the aircraft electric motors may include that each of the inner rotor and the outer rotor comprise magnet Halbach arrays sets with cut-out notches, and each of the inner rotor and the outer rotor comprise respective magnet supports having protrusions engaged with the cut-out notches.

In addition to one or more of the features described herein, or as an alternative, further embodiments of the aircraft electric motors may include one or more thermal dissipation elements on an end face of the magnet support, the thermal dissipation elements configured to increase a surface area of the respective end face of the magnet support.

In addition to one or more of the features described herein, or as an alternative, further embodiments of the aircraft electric motors may include that the one or more thermal dissipation elements comprise a plurality of pins, fins, and/or protrusions In addition to one or more of the features described herein, or as an alternative, further embodiments of the aircraft electric motors may include that the one or more thermal dissipation elements comprise a surface texturing or surface roughness of the respective end face of the magnet support.

In addition to one or more of the features described herein, or as an alternative, further embodiments of the aircraft electric motors may include that each heat pipe extends axially from a forward end face of the magnet support to an aft end face of the magnet support.

According to some embodiments, aircraft include at least one aircraft electric motor, at least one electrical device, and a power distribution system configured to distribute power from the at least one electric motor to the at least one electrical device. The at least one aircraft electric motor includes a rotor assembly comprising a plurality of magnets arranged in magnet Halbach arrays on a magnet support, wherein the magnet support comprising a plurality of protrusions defined on surface thereof and each magnet Halbach array comprises a respective cut-out notch configured to engage with a respective protrusion, an output shaft operably coupled to the rotor assembly, a stator comprising a support structure and at least one winding wrapped about a plurality of stator teeth, the stator configured to generate an electromagnetic field to cause rotation of the rotor assembly, and a heat pipe arranged within each protrusion of the plurality of protrusions, the heat pipe configured to transfer heat away from the magnets.

In addition to one or more of the features described herein, or as an alternative, further embodiments of the aircraft may include that the rotor assembly includes an outer rotor and an inner rotor, wherein the stator is arranged radially between the inner rotor and the outer rotor.

In addition to one or more of the features described herein, or as an alternative, further embodiments of the aircraft may include that each of the inner rotor and the outer rotor comprise magnet Halbach arrays sets with cut-out notches, and each of the inner rotor and the outer rotor comprise respective magnet supports having protrusions engaged with the cut-out notches.

In addition to one or more of the features described herein, or as an alternative, further embodiments of the aircraft may include one or more thermal dissipation elements on an end face of the magnet support, the thermal dissipation elements configured to increase a surface area of the respective end face of the magnet support.

In addition to one or more of the features described herein, or as an alternative, further embodiments of the aircraft may include that the one or more thermal dissipation elements comprise a plurality of pins, fins, and/or protrusions In addition to one or more of the features described herein, or as an alternative, further embodiments of the aircraft may include that the one or more thermal dissipation elements comprise a surface texturing or surface roughness of the respective end face of the magnet support.

In addition to one or more of the features described herein, or as an alternative, further embodiments of the aircraft may include that each heat pipe extends axially from a forward end face of the magnet support to an aft end face of the magnet support.

In addition to one or more of the features described herein, or as an alternative, further embodiments of the aircraft may include that each heat pipe includes a forward heat pipe section and an aft heat pipe section arranged between a forward end face and an aft end face of the magnet support.

In addition to one or more of the features described herein, or as an alternative, further embodiments of the aircraft may include that each heat pipe extends axially from a forward end face of the magnet support to an aft end face of the magnet support and is skewed at an angle relative to a motor axis defined by the rotor assembly.

In addition to one or more of the features described herein, or as an alternative, further embodiments of the aircraft may include that each heat pipe is defined by a bore defined in the material of the magnet support that is filled with a phase-change material and plugged at at least one end of the respective heat pipe.

The foregoing features and elements may be combined in various combinations without exclusivity, unless expressly indicated otherwise. Features which are described in the context of separate aspects and embodiments may be used together and/or be interchangeable. Similarly, features described in the context of a single embodiment may also be provided separately or in any suitable subcombination. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

Various features will become apparent to those skilled in the art from the following detailed description of the disclosed non-limiting embodiments. The drawings that accompany the detailed description can be briefly described as follows:

FIG. 1A is a partial view of an embodiment of electric motor;

FIG. 1B is a cross-sectional view of an embodiment of a stator core of the electric motor of FIG. 1A;

FIG. 2A is a schematic illustration of an aircraft electric motor in accordance with an embodiment of the present disclosure;

FIG. 2B is a side elevation view of the aircraft electric motor of FIG. 2A;

FIG. 2C is a partial cut-away illustration of the aircraft electric motor of FIG. 2A;

FIG. 2D is a separated-component illustration of the aircraft electric motor of FIG. 2A;

FIG. 3A is a schematic illustration of a rotor and stator of an aircraft electric motor in accordance with an embodiment of the present disclosure;

FIG. 3B is a schematic illustration of the rotor and stator of FIG. 3A as arranged within a rotor sleeve in accordance with an embodiment of the present disclosure;

FIG. 4A is a schematic illustration of a radial cross-section of an aircraft electric motor in accordance with an embodiment of the present disclosure;

FIG. 4B is an enlarged illustration of a portion of the structure shown in FIG. 4A;

FIG. 5A illustrates a conventional magnet Halbach array;

FIG. 5B illustrates a first, non-limiting example of a magnet Halbach array having a cut-out notch in accordance with an embodiment of the present disclosure;

FIG. 5C illustrates a second, non-limiting example of a magnet Halbach array having a cut-out notch in accordance with an embodiment of the present disclosure;

FIG. 5D illustrates a third, non-limiting example of a magnet Halbach array having a cut-out notch in accordance with an embodiment of the present disclosure;

FIG. 5E illustrates a fourth, non-limiting example of a magnet Halbach array having a cut-out notch in accordance with an embodiment of the present disclosure;

FIG. 6A is a per-pole cross sectional illustration of a portion of an electric motor in accordance with an embodiment of the present disclosure;

FIG. 6B is a flux density with flux lines plot of the magnetic flux of the portion of the electric motor shown in FIG. 6A;

FIG. 7 is a schematic illustration of a portion of a rotor in accordance with an embodiment of the present disclosure;

FIG. 8 is a schematic view of a power system of an aircraft that may employ embodiments of the present disclosure;

FIG. 9 is a schematic illustration of a portion of an aircraft electric motor having integrated heat pipes in accordance with an embodiment of the present disclosure;

FIG. 10A is a schematic illustration of a portion of an aircraft electric motor having heat pipes in an outer rotor in accordance with an embodiment of the present disclosure;

FIG. 10B is an enlarged detail illustration of a portion of the aircraft electric motor shown in FIG. 10A;

FIG. 11 is a schematic illustration of heat dissipation paths through a portion of an aircraft electric motor in accordance with an embodiment of the present disclosure;

FIG. 12 is a schematic illustration of another embodiment of a portion of an aircraft electric motor in accordance with an embodiment of the present disclosure having heat pipes and thermal dissipation elements;

FIG. 13 is a set of schematic illustrations of cross-sectional shapes of heat pipes that may be used in embodiments of the present disclosure;

FIG. 14A is a schematic illustration of a rotor assembly having heat pipes arranged in accordance with an embodiment of the present disclosure;

FIG. 14B is a schematic illustration of a rotor assembly having heat pipes arranged in accordance with another embodiment of the present disclosure, with the heat pipes arranged with heat pipe sections that are offset from each other;

FIG. 14C is a schematic illustration of a rotor assembly having heat pipes arranged in accordance with another embodiment of the present disclosure, with heat pipes oriented at a skewed angle;

FIG. 15 is a is a schematic illustration of a rotor assembly having heat pipes arranged in accordance with another embodiment of the present disclosure, with the heat pipes arranged with heat pipe sections arranged axially with each other;

FIG. 16A is a schematic illustration of a heat pipe configuration of a rotor assembly in accordance with an embodiment of the present disclosure, having radially angled heat pipes; and

FIG. 16B is a schematic illustration of the rotor assembly of FIG. 16A.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### DETAILED DESCRIPTION

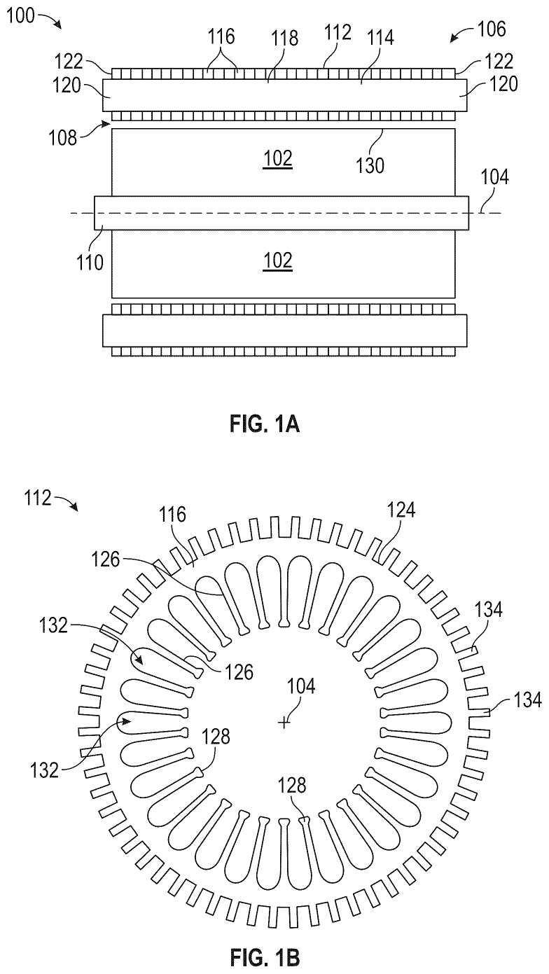

Referring to FIGS. 1A-1B, schematic illustrations of an electric motor 100 that may incorporate embodiments of the present disclosure are shown. FIG. 1A illustrates a cross-sectional view of the electric motor 100 and FIG. 1B illustrates a cross-sectional view of a stator core of the electric motor 100. The electric motor 100 includes a rotor 102 configured to rotate about a rotation axis 104. A stator 106 is located radially outboard of the rotor 102 relative to the rotation axis 104, with a radial airgap 108 located between the rotor 102 and the stator 106. As illustrated, the rotor 102 may be mounted on a shaft 110 which may impart rotational movement to the rotor 102 or may be driven by rotation of the rotor 102, as will be appreciated by those of skill in the art. The rotor 102 and the shaft 110 may be fixed together such that the rotor 102 and the shaft 110 rotate about the rotation axis 104 together as one piece.

The stator 106 includes a stator core 112 in which a plurality of electrically conductive stator windings 114 are disposed. In some embodiments, such as shown in FIG. 1A, the stator core 112 is formed from a plurality of axially stacked laminations 116, which are stacked along the rotation axis 104. In some embodiments, the laminations 116 are formed from a steel material, but one skilled in the art will readily appreciate that other materials may be utilized. The stator windings 114, as shown, include core segments 118 extending through the stator core 112 and end turn segments 120 extending from each axial stator end 122 of the stator core 112 and connecting circumferentially adjacent core segments 118. When the stator windings 114 are energized via an electrical current therethrough, the resulting field drives rotation of the rotor 102 about the rotation axis 104. Although FIG. 1A illustrates the stator core 112 arranged radially inward from the stator windings 114, it will be appreciated that other configurations are possible without departing from the scope of the present disclosure. For example, in some embodiments, the stator structure may be arranged radially inward from a rotating rotor structure.

FIG. 1B is an axial cross-sectional view of the stator core 112. Each lamination 116 of the stator core 112 includes a radially outer rim 124 with a plurality of stator teeth 126 extending radially inwardly from the outer rim 124 toward the rotation axis 104. Each of the stator teeth 126 terminate at a tooth tip 128, which, together with a rotor outer surface 130 (shown in FIG. 1A) of the rotor 102, may define the radial airgap 108. Circumferentially adjacent stator teeth 126 define an axially-extending tooth gap 132 therebetween. Further, in some embodiments, a plurality of stator fins 134 extend radially outwardly from the outer rim 124.

Electric motors, as shown in FIGS. 1A-1B may require cooling due to high density configurations, various operational parameters, or for other reasons. For example, high-power-density aviation-class electric motors and drives may require advanced cooling technologies to ensure proper operation of the motors/drives. These machines are generally thermally limited at high power ratings and their performance can be improved by mitigating thermal limitations. To maintain desired temperatures, a thermal management system (TMS) is integrated into the system, which provides cooling to components of the system. Onboard an aircraft, power requirements, and thus thermal management system (TMS) loads, are substantially higher during takeoff. Sizing of the TMS for takeoff conditions (i.e., maximum loads) results in a TMS having a high weight to accommodate such loads. This results in greater weight and lower power density during cruise conditions which do not generate such loads, and thus does not require a high cooling capacity TMS. Balancing weight constraints and thermal load capacities is important for such aviation applications.

In view of such considerations, improved aviation electric motors are provided herein. The aviation electric motors or aircraft electric motors, described herein, incorporate lightweight materials and compact design to reduce weight, improve thermal efficiencies, improve power efficiencies, and improve power density.

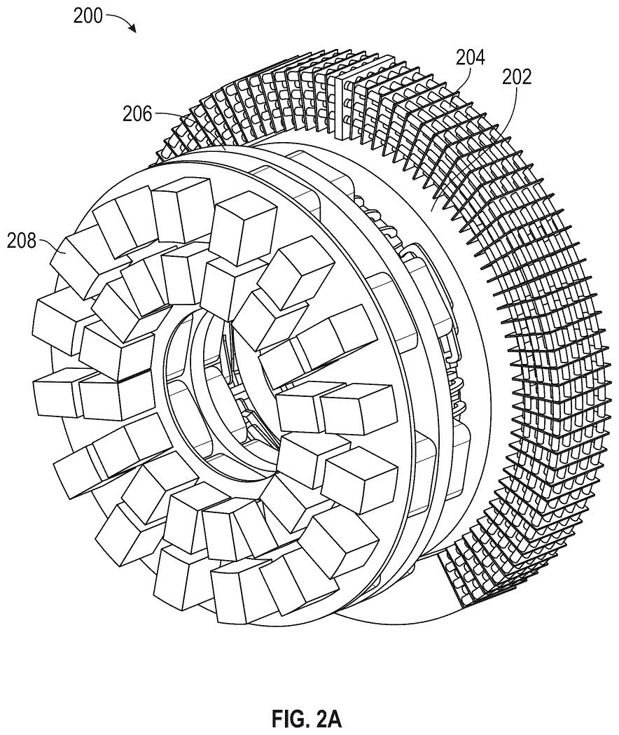

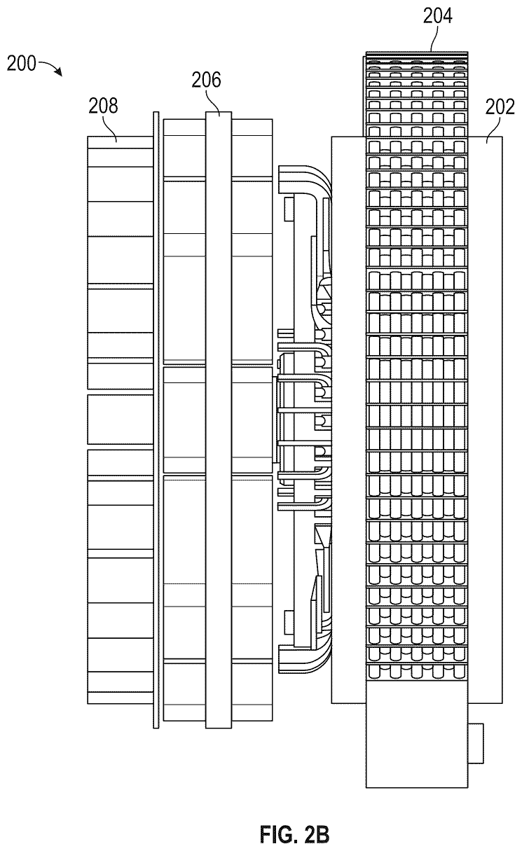

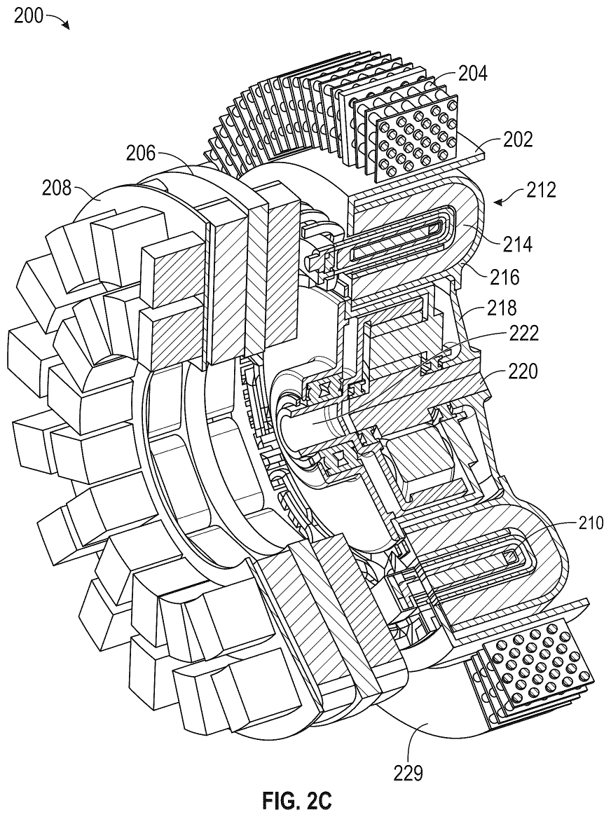

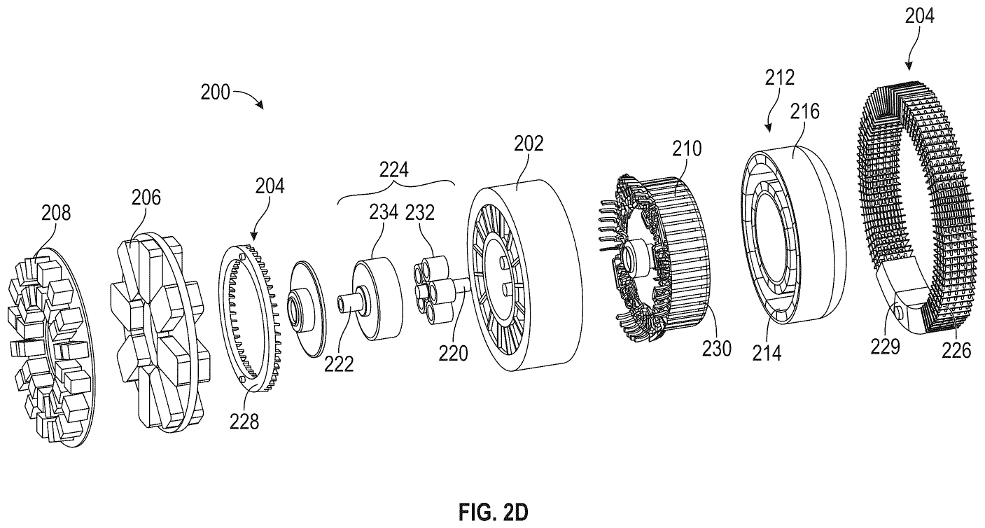

Turning now to FIGS. 2A-2D, schematic illustrations of an aircraft electric motor 200 in accordance with an embodiment of the present disclosure are shown. FIG. 2A is an isometric illustration of the aircraft electric motor 200, FIG. 2B is a side elevation view of the aircraft electric motor 200, FIG. 2C is a partial cut-away view illustrating internal components of the aircraft electric motor 200, and FIG. 2D is a schematic illustration of components of the aircraft electric motor 200 as separated from each other. The aircraft electric motor 200 includes a motor housing 202, a cooling system 204, a first power module system 206, and a second power module system 208.

The motor housing 202 houses a stator 210 and a rotor 212, with the rotor 212 configured to be rotatable about the stator 210. In this illustrative embodiment, the rotor 212 includes a U-shaped magnet 214 arranged within a similarly shaped U-shaped rotor sleeve 216. The rotor sleeve 216 is operably connected to a hub 218. The hub 218 is fixedly attached to a first shaft 220. The first shaft 220 is operably connected to a second shaft 222. In some configurations, the first shaft 220 may be a high speed shaft and may be referred to as an input shaft. In such configurations, the second shaft 222 may be a low speed shaft and may be referred to as an output shaft. The connection between the first shaft 220 and the second shaft 222 may be by a gear assembly 224, as described herein.

The cooling system 204 is configured to provide cooling to the components of the aircraft electric motor 200. The cooling system 204, as shown in FIG. 2D, includes a heat exchanger 226 and a header 228. The heat exchanger 226 and the header 228 may form a closed-loop cooling system that may provide air-cooling to a working fluid at the heat exchanger 226. The header 228 may be, in some configurations, a two-phase di-electric cooling header. A cooled working fluid may be pumped from the heat exchanger 226 into the header 228 using a pump 229 and distributed into embedded cooling channels 230 that are arranged within the stator 210. As the aircraft electric motor 200 is operated, heat is generated and picked up by the working fluid within the embedded cooling channels 230. This heated working fluid is then passed through the header 228 back to the heat exchanger 226 to be cooled, such as by air cooling. Although described as air-cooling, other cooling processes may be employed without departing from the scope of the present disclosure.

As shown, the heat exchanger 226 of the cooling system 204 may be a circular or annular structure that is arranged about the motor housing 202. This configuration and arrangement allows for improved compactness of the system, which may be advantageous for aircraft applications. The rotor sleeve 216 with the magnets 214, the stator 210, and the gear assembly 224 fit together (although moveable relative to each other) within the motor housing 202, providing for a compact (low volume/size) design.

As noted above, the rotor sleeve 216 may be operably coupled to a first shaft 220 by the hub 218. The first shaft 220 may be operably coupled to a first gear element 232 and the second shaft 222 may be operably coupled to a second gear element 234. The first and second gear elements 232, 234 may form the gear assembly 224. The first and second gear elements 232, 234 are arranged to transfer rotational movement from the first shaft 220, which is driven in rotation by the hub 218 and the rotor sleeve 216 of the rotor 212, to the second shaft 222. In some embodiments, the first shaft 220 may be operably connected to a sun gear as the first gear element 232 that engages with a plurality of planetary gears and drives rotation of the second gear element 234 which may be operably connected to the second shaft 222. In some embodiments, the second shaft 222 may be connected to a fan or other component to be rotated by the aircraft electric motor 200.

The aircraft electric motor 200 includes the first power module system 206 and the second power module system 208. The first and second power module systems 206, 208 can include capacitors and other electronics, including, but not limited to, printed circuit boards (PCBs) that are configured to control and operate the aircraft electric motor 200. Again, the profile of the aircraft electric motor 200 of the present disclosure presents a low profile or compact arrangement that reduces the volume of the entire power system, which in turn can provide for improved weight reductions. In some embodiments, the first and second power module systems 206, 208 may be electrically connected to the stator 210 to cause an electric current therein. As the electric current will induce an electromagnetic field which will cause the rotor 212 to rotate.

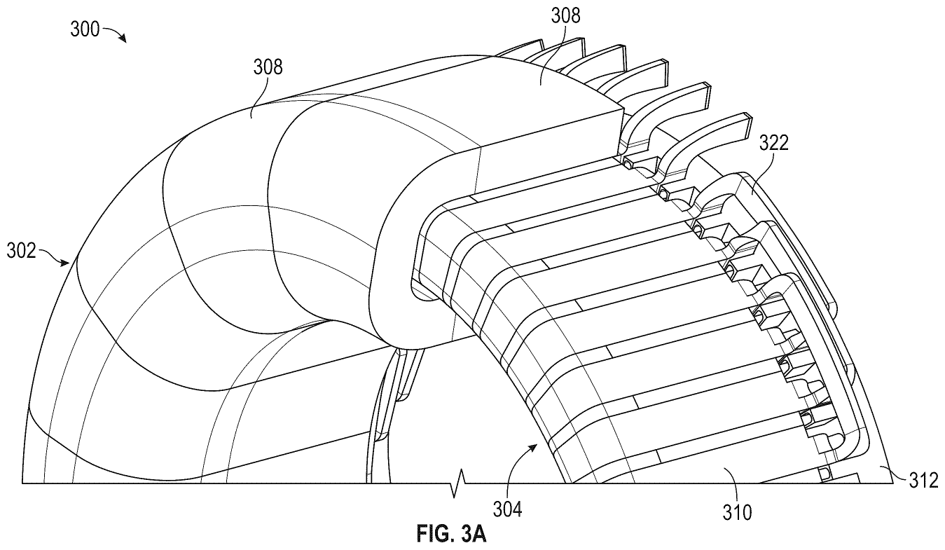

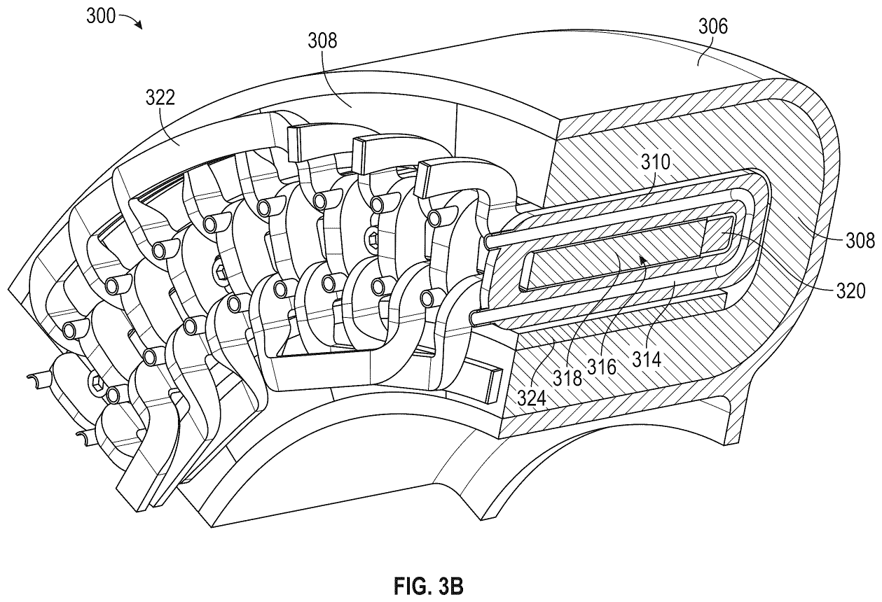

Referring now to FIGS. 3A-3B, schematic illustrations of a portion of an aircraft electric motor 300 in accordance with an embodiment of the present disclosure is shown. FIGS. 3A-3B illustrate a portion of a rotor 302 and a stator 304 of the aircraft electric motor 300. FIG. 3A illustrates the rotor 302 and the stator 304 and FIG. 3B illustrates these components arranged within a rotor sleeve 306.

The rotor 302 is formed of a plurality of U-shaped magnets 308. In some configurations, the plurality of magnets 308 can be arranged with alternating polarity in a circular structure. Arranged within the “U” of the U-shaped magnets 308 is the stator 304. The stator 304 is formed of a plurality of windings 310. In this configuration, the windings 310 are arranged with a header 312. The header 312 may be part of a cooling system, such as that shown and described above. The header 312 can be configured to cycle a working fluid through cooling channels 314 for cooling of the windings 310, as shown in FIG. 3B.

The windings 310 may be wrapped about a support structure 316 (e.g., back iron or yoke). The support structure 316, in some embodiments and as shown in FIG. 3B, may include a laminate portion 318 and a magnetic portion 320. In some such embodiments, the laminate portion 318 may be formed from cobalt steel laminate and the magnetic portion 320 may be formed from a soft magnetic composite. The laminate portion 318 may be provided to capture in-plane flux from outer and inner rotor. The magnetic portion 320 may be provided to capture end rotor flux and may take a shape/filler in a gap through the end turns of the coil. The windings 310 include end connections 322 and may be electrically connected to one or more power module systems of the aircraft electric motor, such as shown above.

As shown in FIG. 3B, the magnets 308 are U-shaped and arranged within the rotor sleeve 306. The rotor sleeve 306 is a substantially U-shaped sleeve that is sized and shaped to receive the U-shaped magnets 308. In this illustrative configuration, the rotor sleeve 306 can include an inner sleeve 324. The inner sleeve 324 may be configured to provide support to a portion of the magnets 308. It will be appreciated that there is no direct contact between the windings 310 and the magnets 308. This lack of contact allows for free rotation of the rotor 302 relative to the stator 304 during operation.

In aviation-class electric motors, such as shown and described above, a high-power density can be achieved by maximizing torque at a given speed. The torque density can be increased by improving utilization of magnetic materials and increase magnetic loading. Prior concepts for maximizing power density was achieved through minimizing the core of the rotor system. However, such minimization has an impact on magnetic loading (average airgap flux density). Conventionally, introducing a magnetic tooth can increase magnetic loading but may also increase torque ripple. Torque ripple is an effect seen in electric motor designs and refers to a periodic increase or decrease in output torque as the motor shaft rotates. Accordingly, it is desirable to both maximize magnetic loading while minimizing torque ripple. In view of this, embodiments of the present disclosure are directed to incorporating non-magnetic teeth and/or non-magnetic back iron, yoke, or support structure within the motor assembly. The non-magnetic structures (teeth and/or support structure) are made from non-magnetic materials (e.g., potting material, ceramic, etc.) may be infused or embedded with magnetic wires In accordance with embodiments of the present disclosure, the introduction of magnetic wire-infused teeth and/or support structures results in reduced weight and improved power density. Further, advantageously, such configurations can provide a low weight solution without sacrificing average torque of the motor. Shaping of the wires near an airgap (e.g., to the magnets of the motor) can also help manipulate the harmonics in the airgap and result in redistribution of torque ripple harmonics and reduce torque ripple without impacting average torque.

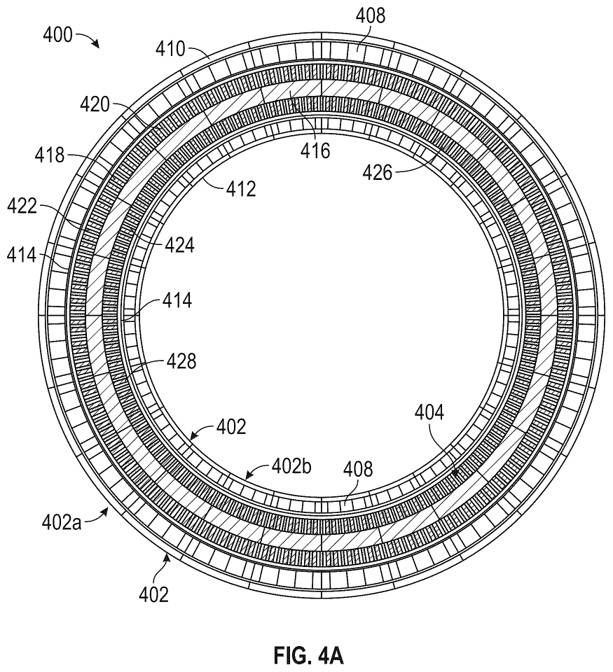

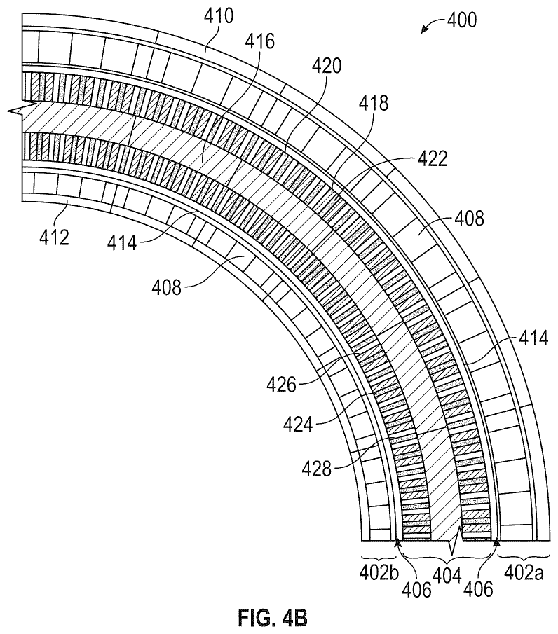

Referring to FIGS. 4A-4B, schematic illustrations of a portion of an aircraft electric motor 400 in accordance with an embodiment of the present disclosure is shown. FIGS. 4A-4B illustrate a portion of a rotor 402 and a stator 404 of the aircraft electric motor 400. FIG. 4A illustrates the full circular structure of the rotor 402 and the stator 404 and FIG. 4B illustrates an enlarged illustration of a portion of the rotor 402 and the stator 404. The rotor 402 and the stator 404 may be part of an aircraft electric motor similar to that shown and described herein and used as described herein.

As shown, the rotor 402 is arranged about the stator 404, with an outer portion 402a and an inner portion 402b arranged radially outward and inward from the stator 404, respectively. The outer and inner portions 402a, 402b may be parts of a substantially U-shaped magnet assembly, as shown and described above. The stator 404 is arranged between the outer and inner portions 402a, 402b with an airgap 406 therebetween, as shown in FIG. 4B. The rotor 404 includes a plurality of magnets 408, which may be substantially U-shaped and span from the outer portion 402a to the inner portion 402b. An outer rotor sleeve 410 and an inner rotor sleeve 412 may be separate components or a continuous structure, as shown and described above, and are configured to support and retain the magnets 408 of the rotor 402. Further, one or more retention sleeves 414 may be arranged on a side of the magnets 408 that faces the stator 404. The rotor 402 is configured to be rotationally driven by current that is passed through the stator 404.

The stator 404 includes a support structure 416 (e.g., a back iron or yoke). The support structure 416 supports, on a radial outer side thereof, a plurality of outer teeth 418, outer coils 420, and outer cooling channels 422. Similarly, on a radially inner side of the support structure 416 are arranged a plurality of inner teeth 424, inner coils 426, and inner cooling channels 428.

In some embodiments of the present disclosure, one or more of the outer teeth 418, the inner teeth 424, and/or the support structure 416 may be made of a non-magnetic material with embedded magnetic wires. In some example embodiments, each of the outer teeth 418 the inner teeth 424, and/or the support structure 416 may be formed of a non-magnetic material with embedded magnetic wires and shaped to reduce torque ripple while increasing magnetic loading and improving manufacturability and address stack-up tolerance challenges.

As shown in FIG. 4A, the rotor 402 and stator 404 form a substantially ring-shape or annular shape. As shown, the outer teeth 418 and the inner teeth 424 are each arranged in a circumferential arrangement and extend radially from the support structure 416. The outer teeth 418 extend radially outward from the support structure 416 and the inner teeth 424 extend radially inward from the support structure 416. In some configurations, the teeth 418, 424 may be the same in shape, orientation, material, and the like about the circumferences of the stator 404. In other embodiments, the teeth 418, 424 may be arranged in sets or specific configurations arranged in a repeating pattern about the respective circumferential arrangement.

Permanent magnet motors are widely used for high power density and efficient applications in aviation industry. The high torque density can be achieved by maximizing the magnetic loading through implementation of the Halbach array permanent magnet rotor structure; however, the dense permanent magnets can be a major barrier when minimizing the weight of the application. Accordingly, improved electric motor components may be used to improve the weight of such electric motors while also provide additional benefits, such as improved power density and the like.

In accordance with embodiments of the present disclosure, optimal shaped Halbach array magnets with a notch cut-out in the inner rotor and outer rotor are provided. The modified magnets may effectively reduce the weight of the magnets while also improving the power density thereof. In accordance with some embodiments, the notch cut-out may be made at an in-pole magnetization magnet (i.e., magnetization orthogonal to the airgap) in the Halbach array and may be positioned such that the cut-out is not in the magnetic flux path, resulting in minimal impact on torque production. In accordance with some embodiments, the notch shape cut-out area can be optimized in a way such that the magnet weight reduction is maximized while the torque impact is minimized. Magnet loss is reduced accordingly, improving the efficiency and life of motors. In some configurations and arrangements in accordance with embodiments of the present disclosure, when the magnetic flux is substantially constant along the Halbach array structure it is indicative that the magnet materials are used optimally and effectively. In some embodiments, the cut-out area can be replaced by a rotor dovetail for magnet insertion onto the rotor structure, providing improved mechanical integrity.

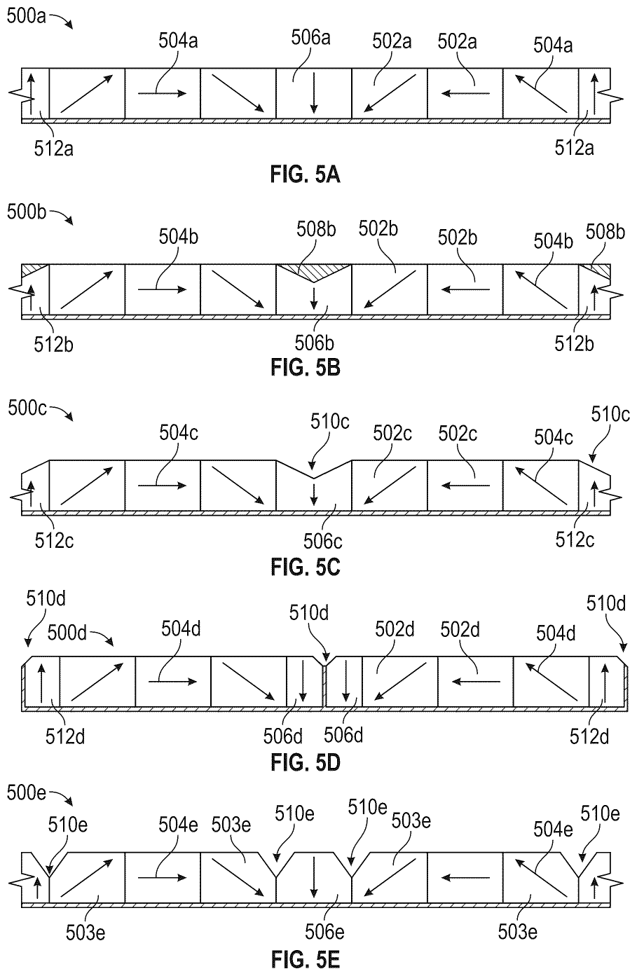

Referring now to FIGS. 5A-5E, schematic illustrations of different magnet Halbach arrays 500a-d are shown. The magnet Halbach arrays 500a-d may be incorporated into an electric motor or the like, as shown and described above. Although illustratively shown as linear arrays, those of skill in the art will appreciate that this is merely representative (i.e., the number of arrays is not limited to four as illustrated and can be other count), and the magnet Halbach arrays 500a-d may be configured as part of a circular or annular structure to be arranged, for example, within a system as shown and described above.

A first magnet Halbach array 500a (FIG. 5A) is illustrative of a conventional Halbach Array. The first magnet Halbach array 500a is formed from a set of magnets 502a that are arranged to cause a magnetic field 504a to be formed thereby. The magnetic field 504a is illustratively shown by arrows indicative of the magnetic field direction. An in-pole magnetization magnet 506a is shown where the magnetic field 504a aligns between two fields (i.e., left and right of the in-pole magnetization magnet 506a).

A second magnet Halbach array 500b (FIG. 5B) is shown in accordance with an embodiment of the present disclosure. As shown, the second magnet Halbach array 500b is a modification of the conventional Halbach Array, as configured in the first magnet Halbach array 500a. The second magnet Halbach array 500b is formed of a set of magnets 502b arranged similarly to that in the first magnet Halbach array 500a, but includes a reduction region 508b that indicates material of an in-pole magnetization magnet 506b that may be removed. As shown, the magnetic field 504b of the second magnet Halbach array 500b is essentially the same as the magnetic field 504a of the first magnet Halbach array 500a.

A third magnet Halbach array 500c (FIG. 5C) in accordance with an embodiment of the present disclosure, illustrates a configuration where material of an in-pole magnetization magnet 506c is removed in the form of a cut-out notch 510c. Similar to the first and second magnet Halbach arrays 500a, 500b, the third magnet Halbach array 500c has a similar magnetic flux and field orientation. The cut-out notch 510c serves reduce the material and weight of the in-pole magnetization magnet 506c. As illustratively shown, a magnetic field 504c generated by magnets 502c of the third magnet Halbach array 500c is similar to that of the first and second magnet Halbach arrays 500a, 500b. It has been observed that such cut-out notches 510c, as implemented in in-pole magnetization magnets (e.g., in-pole magnetization magnet 5106c) that are not in the magnetic flux path, does not significantly or appreciably impact the operational capacity of the magnet Halbach array.

A fourth magnet Halbach array 500d (FIG. 5D) in accordance with an embodiment of the present disclosure, is shown with an in-pole magnetization magnet 506d that is a split magnet. The fourth magnet Halbach array 500d is formed of a set of magnets 502d that generate a magnetic field 504d. Because the in-pole magnetization magnet 506d is a split magnet, a cut-out notch 510d may be provided at the interface between the two split magnets of the in-pole magnetization magnet 506d. As shown in this illustration, the far ends of the illustrative fourth magnet Halbach array 500d may also include cut-out notches 510d and may be formed of split magnets similar to the split in-pole magnetization magnet 506d. That is, the far ends of the illustrative fourth magnet Halbach array 500d are the same magnet but opposite magnetization with the same cut-out notches.

A fifth magnet Halbach array 500e (FIG. 5E) in accordance with an embodiment of the present disclosure, is shown with an in-pole magnetization magnet 506e that is a single magnet (although a split magnet similar to 506d may be employed). The fifth magnet Halbach array 500e is formed of a set of magnets that generate a magnetic field 504e. In this configuration, the in-pole magnetization magnet 506e includes two cut-outs 510e at sides of the in-pole magnetization magnet 506e. As a result, the adjacent non-in-pole magnetization magnets (labeled 503e) may also include a cut-out notch or part of a cut-out notch. As such, in accordance with some embodiments of the present disclosure, there are some configurations where the in-pole magnetization magnet includes at least a part of the cut-notch, but not necessarily the entire cut-out notch. For example, as shown, a part of the cut-out notch may be formed by an adjacent non-in-pole magnetization magnet 503e. Although shown with two cut-out notches 510e, in other embodiments, one or the other cut-out notch 510e may be removed, such that only one of the two cut-out notches 510e is present.

As used herein, the term “in-pole magnetization magnet” refers to a magnet of a magnetic array or set that has magnetization orthogonal to the air gap (e.g., directly into the air gap). Stated another way, in the case of circular rotors and thus arcuate sets of magnets or arcuate sets of magnet arrays, the in-pole magnetization magnet is the magnet having a radial direction of magnetization (either radially inward or radially outward). In FIG. 5, the central magnet 506a-d of each array 500a-d is an in-pole magnetization magnet, with the magnetization oriented downward on the page (or radially inward in the case of a circular rotor). In the illustrated drawings, the farthest end magnets 512a-d are also in-pole magnetization magnets, although with a magnetization orientated upward on the page (or radially outward in the case of a circular rotor).

In the illustrative configurations of the third and fourth magnet Halbach arrays 500c, 500d, the cut-out notches 510c, 510d are illustrated having different relative sizes as compared to the respective in-pole magnetization magnets 506c, 506d. For example, in some embodiments, the single-magnet 510c could have a geometric shape similar to that shown with respect to the split-magnet 510d, or vice versa. Further, it will be appreciated that the size, shape, and dimensions of the cut-out notches of embodiments of the present disclosure may take any form to achieve a reduction in weight while maintaining or increased electric motor efficiencies. For example, the amount of material removed to form the cut-out notches, in accordance with some non-limiting embodiments of the present disclosure may be between 5% and 40% of the total magnet volume. In some embodiments, the removed material may be between 10% and 20%, and in some embodiments may be less than 25% of the total volume. The amount of material removed is selected to reduce the weight without impairing the power density of a given design and thus may be selected based on a particular configuration and/or application. When referring to the amount of material removed with respect to a split-magnet, because the measurement is based on volume, there is no change in the respective measurements and ratios. However, in some embodiments, even when using a split-magnet, the reduction in volume may be based on a calculation of the combined split-magnet (i.e., both halves) and not referring specifically to each separate portion of the split-magnet.

The magnets of the various configurations may be permanent magnets, which may be formed from, for example and without limitation, neodymium, samarium cobalt, alnico, ferrite, or other materials, as will be appreciated by those of skill in the art. The permanent magnets, formed from these materials, are relatively heavy, and thus the reduction of even some of the material can provide weight advantages as compared to systems that do not include such cut-out notches. As such, improved wight reductions may be achieved through implementation of embodiments described herein. Moreover, the cut-out notch may improve the power density of electric motors that incorporate such embodiments. For example, when considering a lightweight aerospace permanent magnet motor relying on dense neodymium Halbach array magnets to produce high rotor magnetic loading, a 25% reduction in volve of an in-pole magnetization magnet, as described herein, can result in approximately 10-15% rotor weight reduction resulting in an improved power-to-weight ratio of the motor.

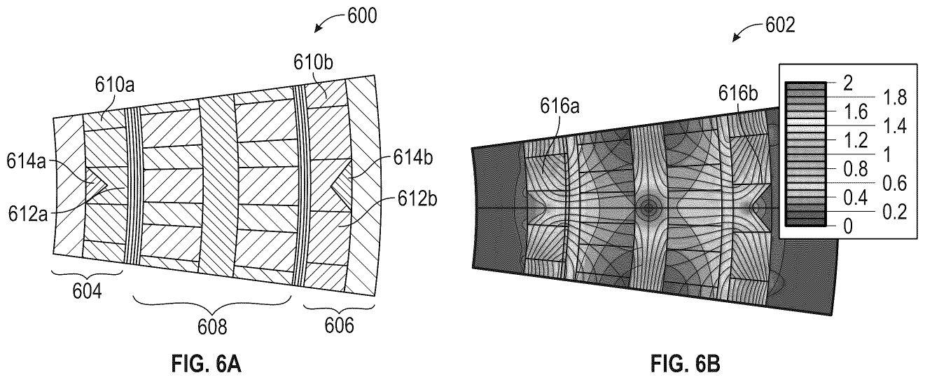

Referring now to FIGS. 6A-6B, schematic illustrations of an embodiment of the present disclosure are shown. FIG. 6A illustrates a portion of an electric motor 600 that incorporates features of the present disclosure and FIG. 6B is a magnetic flux diagram 602 representative of the magnetic flux of the portion of the electric motor 600 shown in FIG. 6A. The electric motor 600 includes an inner rotor 604, an outer rotor 606, and a stator 608 arranged therebetween. The rotors 604, 606 and the stator 608 may be configured and arranged within the electric motor 600 in a manner as shown and described above. Each of the rotors 604, 606 are formed from magnet Halbach arrays 610a, 610b arranged in sets of Halbach arrays or the like. Similar to some of the configurations shown in FIG. 5, an in-pole magnetization magnet 612a, 612b of the inner rotor 604 and the outer rotor 606, respectively, includes a cut-out notch 614a, 614b, respectively. The magnetic flux of the electric motor 600 in the magnetic flux diagram 602 of FIG. 6B. As shown, there is a constant flux density 616a, 616b even with inclusion of the cut-out notches 614a, 614b. That is, the removal of material of the in-pole magnetization magnets 612a, 612b does not negatively impact the magnetic flux of the respective magnet Halbach arrays 610a, 610b. The cut-out notch 614a, 614b may be empty (i.e., air-filled) or may be replaced with a light-weight material or filler that may serve to fill the space of the cut-out notch 614a, 614b without significantly increasing the weight of the electric motor 600 (e.g., as compared to notched magnets with no filler).

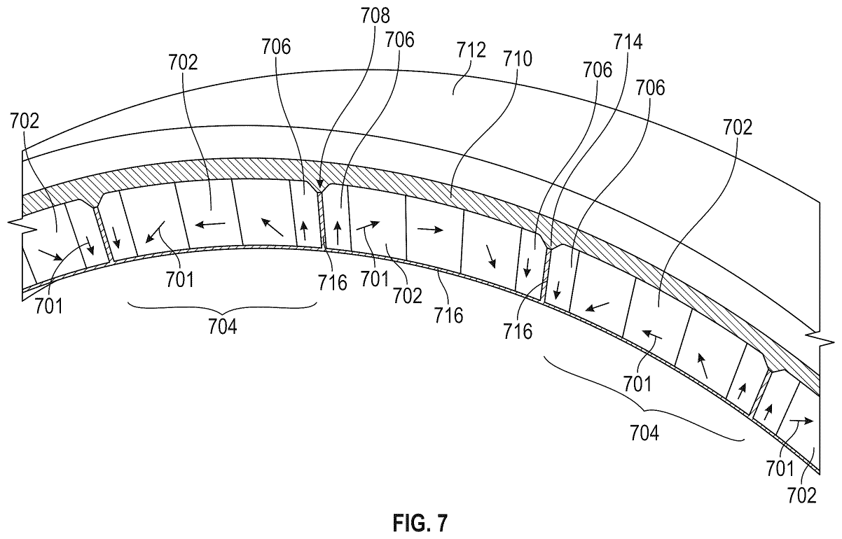

Referring now to FIG. 7, a schematic illustration of a portion of a rotor 700 for use in an electric motor in accordance with an embodiment of the present disclosure is shown. The rotor 700 in this illustrative embodiment is configured as an outer rotor that is intended to be positioned radially outward from a stator, and a second (inner) rotor may be positioned radially inward from the stator (e.g., as shown in FIGS. 4A-4B).

The rotor 700 is formed from a plurality of magnets 702 that are arranged to form the rotor 700. The magnets 702 are grouped into sets 704, which may be referred to as a pole. Each set 704 of magnets 702 may include a split magnet 706 at the ends of each set 704. For two adjacent sets 704, the split magnets 706 at the ends of the respective sets 704 are arranged adjacent to each other. Further, the split magnets 706, when arranged in the rotor 700 define a cut-out notch 708, similar to that shown and described above. The split magnets 706 may be arranged as in-pole magnetization magnets that have a magnetization that is oriented in a radial direction relative to the rotor 700 (e.g., either radially inward or radially outward), as shown by the magnetization arrows 701 illustrated in FIG. 7 In this illustrative configuration, the magnets 702 are supported in the rotor 700 on a magnet support 710, which may be a metallic (e.g., aluminum or other metal) structure. Wrapped about the magnet support 710 is a rotor wrap 712. The rotor wrap 712, in some non-limiting embodiments, may be formed of carbon fiber or other material. It will be appreciated that the rotor wrap 712 may be formed from a non-metallic and/or non-magnetic material and the magnet support 710 may be formed a non-magnetic metal or other material to provide structural stability and support to the magnets 702 during operation of the rotor 700 when installed within an electric motor or the like.

The magnet support 710 may include protrusions 714 that are sized and shaped to fill the cut-out notch 708 between the split magnets 706, as shown in FIG. 7. It will be appreciated that in other configurations, a split magnet may not be employed, but rather a single magnet with a cut-out notch may be provided (e.g., as shown in FIG. 5). However, as illustrated, the magnets between adjacent sets 704 of magnets 702 are formed as the split magnets 706. The rotor 700 may include a binder 716 that is configured to bond the magnets 702, 706 together. As shown, the binder 716 may be applied to an inner radial surface of the magnets 702, 706. As such, the magnets 702, 706 are retained within the rotor 700 between the binder 716 on a first side (e.g., the radially inward side in this illustration) and the magnet support 710 on a second side (e.g., the radially outward side). It will be appreciated that for an inner rotor configuration (e.g., inner rotor 604 shown in FIG. 6A), the binder may be arranged on the radially outward side of the magnets and the magnet support may be arranged on the radially inward side of the magnets. As such, the illustrative arrangement and orientation of components is not intended to be limiting, but rather is provided for illustrative and explanatory purposes. The binder 716 may be an epoxy or other similar material that does not impact the magnetic properties of the magnets 702, 706, but provides a mechanical and/or structural mechanism to hold and retain the magnets 702, 706 in place.

In the illustrative embodiment of FIG. 7, the binder 716 may be arranged between the split magnets 706 of adjacent sets 704 of magnets 702. In some embodiments, the binder may have a thickness that is sufficiently small to avoid impacting the magnetic field properties of the split magnets 706. For example, in a non-limiting embodiment, the binder 716 may have a thickness of between 0.2 mm and 1.0 mm, or between 0.4 mm and 0.8 mm, or about 0.6 mm. Further, the binder 716 may be arranged to bind or attach the surfaces of the split magnets 706 that define the cut-out notch 708 to the protrusions 714 of the magnet support 710. In some embodiments, the protrusions 714 may form dovetail structures for receiving the magnets 702 and provide additional structural retention of the magnets 702 to the magnet support 710.

In FIG. 7, each set 704 of magnets 702 is formed of three full magnets 702 and two split magnets 706 at each end of the set 704. In a configuration with non-split magnets, each set 704 of magnets 702 may share an end magnet with an adjacent set (e.g., as shown in FIG. 5), with the end magnets having the cut-out notch formed therein. Although shown with three whole magnets and a notched magnet (either split or not) at the ends of the sets 704, those of skill in the art will appreciate that each set may be formed of any number of magnets, and the illustrative configurations are merely provided for illustrative and explanatory purposes.

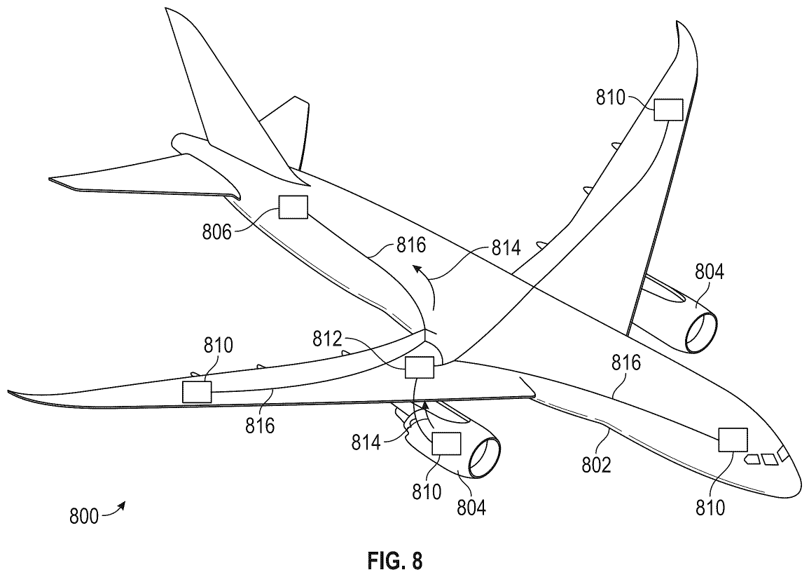

Referring now to FIG. 8, a power system 800 of an aircraft 802 is schematically shown. The power system 800 includes one or more engines 804, one or more electric motors 806, a power bus electrically connecting the various power sources 804, 806, and a plurality of electrical devices 810 that may be powered by the engines 804 and/or motors 806. The power system 800 includes a power distribution system 812 that distributes power 814 through power lines or cables 816. The electric motors 806 be configured as the aircraft electric motors shown and described herein and/or incorporate features as described herein.

In accordance with some embodiments of the present disclosure, Halbach array magnets with a notch cut-out in the rotor and having integrated heat pipes are provided. That is, in addition to provide the features and functionality described above with respect to the notched magnet configurations, in some embodiments, the notched portions/regions may be provided with cooling features, such as heat pipes, that can provide improved cooling and thermal management for the magnets of the arrays. Such configurations can provide effective mechanisms for reducing the weight of the magnet assemblies. Additionally, the notches having integrated heat pipes can improve the power density and thermal management by removing heat away from the magnets, particularly those in the center (e.g., axially) or magnet portions in the center of a given array. In accordance with some embodiments, the notch may be located at the center magnet in the Halbach array, with such magnet not in the magnetic flux path, resulting in minimal impact on torque production and magnet weight reduction. Additionally, the notch can serve as a locating feature during assembly process and a torque transfer feature during rotation of the rotors having the magnet assemblies. The integrated heat pipes can also improve heat rejection from the magnets, thereby improving the efficiency of motors

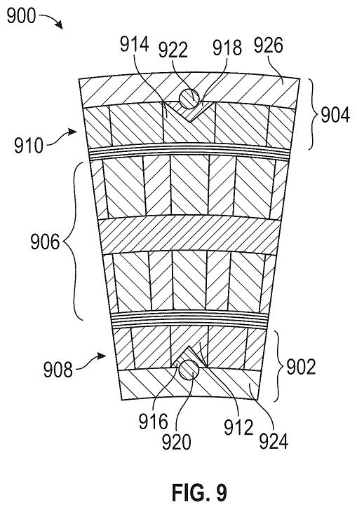

Referring now to FIG. 9, a schematic illustration of an embodiment of the present disclosure is shown. FIG. 9 illustrates a portion of an electric motor 900 that incorporates features of the present disclosure. The electric motor 900 includes an inner rotor 902, an outer rotor 904, and a stator 906 arranged therebetween. The rotors 902, 904 and the stator 906 may be configured and arranged within the electric motor 900 in a manner as shown and described above. Each of the rotors 902, 904 are formed from magnet Halbach arrays 908, 910 arranged in sets, arrays, or the like. Similar to some of the configurations shown in FIG. 5, an in-pole magnetization magnet 912, 914 of the inner rotor 902 and the outer rotor 904, respectively, includes a cut-out notch 916, 918, respectively. In this configuration, the cut-out notches 916, 918 may be filled, at least partially, by a respective heat pipe 920, 922 or such heat pipes 920, 922 may be installed or arranged within the cut-out notches 916, 918. In some embodiments, the heat pipes 920, 922 may be seated, set, or housed within a light-weight material or filler that may serve to fill the remainder volume of the respective cut-out notches 916, 918, around the respective heat pipes 920, 922. In such configurations, the light-weight material or filler may have a relatively high thermal conductivity to support removal of heat from the magnets

The magnet Halbach arrays 908, 910 may be supported on respective rotor sleeves, with the inner magnet Halbach array 908 supported on an inner rotor sleeve 924 and the outer magnet Halbach array 910 supported on an outer rotor sleeve 926. As shown in FIG. 9, the heat pipes 920, 922 may be partially embedded within the material that fills the cut-out notches 916, 918 and/or partially embedded within the material of the respective rotor sleeves 924, 926. The heat pipes 920, 922 are positioned to absorb heat generated by the magnet Halbach arrays 908, 910 and transfer the heat into the respective rotor sleeves 924, 926 and/or to an ambient environment (e.g., to air). Although shown with the heat pipes 920, 922 partially embedded in each of the respective cut-out notches 916, 918 and rotor sleeves 924, 926, such configuration is not intended to be limiting. In other embodiments, the heat pipes may be fully embedded within the cut-out notches or may be fully embedded within the rotor sleeves.

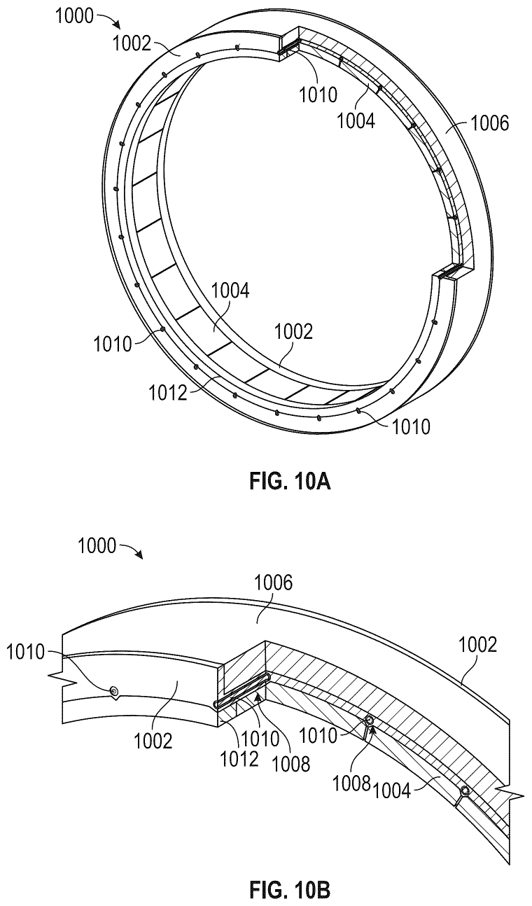

Referring now to FIGS. 10A-10B, schematic illustrations of an embodiment of the present disclosure are shown. FIG. 10A illustrates a partial-cut away schematic view of an outer rotor 1000 and FIG. 10B illustrates an enlarged view of a portion of the outer rotor 1000. Although FIGS. 10A-10B are illustrative of an outer rotor, it will be appreciated that an inner rotor assembly may be configured substantially similarly, although opposite with respect to radial position/arrangement of components, such as shown and described above. The outer rotor 1000 includes a magnet support 1002 with a set of magnet Halbach arrays 1004 arranged on an inner diameter surface thereof. As illustrated each of the magnet Halbach arrays 1004 is shown as a unitary structure. However, it will be appreciated that the magnet elements of the magnet Halbach arrays 1004 may be configured as shown and described above, and individual magnet elements may be configured to form the magnet Halbach arrays 1004.

The magnet Halbach arrays 1004 are arranged on an inner diameter surface of the magnet support 1002. A rotor sleeve 1006 is arranged on an outer diameter surface of the magnet support 1002. In accordance with some embodiments, the magnet support 1002 may be a metal structure and may be selected or configured with a relatively high thermal conductivity, whereas the rotor sleeve 1006 may be formed from composite materials and may have a low thermal conductivity.

The magnet support 1002 includes a set of protrusions 1008 that are configured to be seated in or support a cut-out notch of the magnet Halbach arrays 1004, similar to that shown and described above. The magnet Halbach arrays 1004 may have in-pole magnetization magnets with respective cut-out notches, as shown and described above. In this configuration, the protrusions 1008 of the magnet support 1002 include respective heat pipes 1010. As such, the heat pipes 1010 are arranged within thermal connection with surfaces of the magnets of the magnet Halbach arrays 1004, specifically, in this embodiment, along the protrusions 1008 of the magnet support 1002 that engage with the cut-out notches of the magnet Halbach arrays 1004. The heat pipes 1010 extend in an axial direction through the structure of the outer rotor 1000, thermally connecting the axially inner portions of the magnet Halbach arrays 1004 with the exterior material of the magnet support 1002, thereby providing thermal energy dissipation from the magnets. As shown, the assembly of the magnet support 1002 may include a rotor end ring 1012. The rotor end ring 1012 may be installed to the magnet support 1002 to axially secure and retain the magnet Halbach arrays 1004 within or on the magnet support 1002. The rotor end ring 1012 may be of a same or similar material as the magnet support 1002, and in some embodiments may be a metal material with a relatively high thermal conductivity.

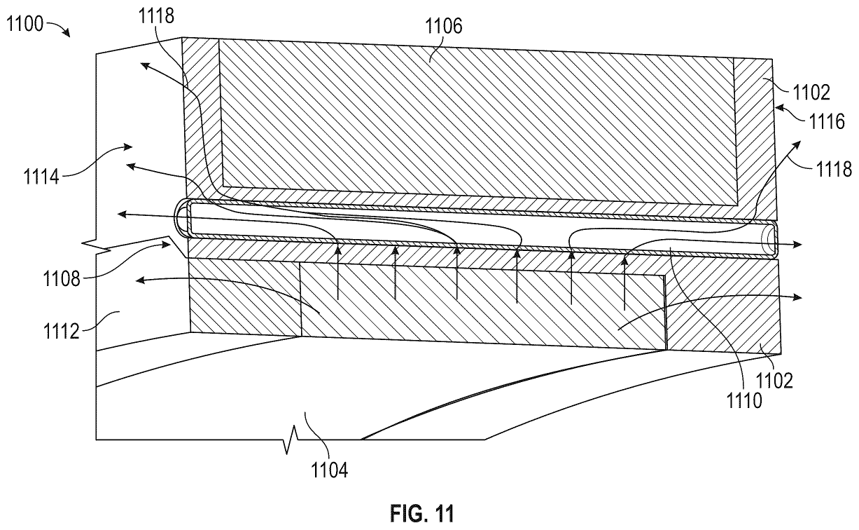

Referring now to FIG. 11, a schematic illustration of thermal transfer from a magnet Halbach arrays 1104 through a magnet support 1102 of a portion of an outer rotor 1100 in accordance with an embodiment is shown. The outer rotor 1100 may be arranged substantially similar to that shown in FIGS. 10A-10B. The magnet support 1102 supports the magnet Halbach arrays 1104 on an inner diameter surface and a rotor sleeve 1106 is arranged on an outer diameter surface thereof. A rotor end ring 1112 may axially retain the magnet Halbach arrays 1104 on the magnet support 1102. The magnet support 1102 includes a set of protrusions 1108 that are configured to engage with a cut-out notch of the magnet Halbach arrays 1104, as shown and described above.

As shown, the protrusion 1108 includes a heat pipe 1110 arranged therein. As show, the heat pipe 1110 extends the axial span of the magnet support 1102, from a forward end face 1114 to an aft end face 1116. It will be appreciated that in other configurations, the heat pipes may be arranged to span a partial distance across the axial span. In some such embodiments, a staggered or patterned arrangement of heat pipes may be employed without departing from the scope of the present disclosure.

FIG. 11 illustratively shows heat dissipation lines 1118. During operation, the magnet Halbach arrays 1104 will heat up as the outer rotor 1100 is rotationally driven. Heat generated by the magnets of the magnet Halbach arrays 1104 may be dissipated through the material of the magnet support 1102 and the rotor end ring 1112. However, heat that is generated in the axially center portion of the magnet Halbach arrays 1104 may not easily be dissipated. For example, the rotor sleeve 1106 may be a composite material with low thermal conductivity, and thus heat from the axially central portions of the magnet Halbach arrays 1104 may not easily be removed. To provide heat conduction and removal, the heat pipes 1110 are provided within the protrusions 1108 of the magnet support 1102. The heat pipes 1110 are thus arranged in thermal communication with the magnet Halbach arrays 1104 along the length of the protrusion 1108 and respective surfaces for the cut-out notches of the magnets. Accordingly, heat may be removed from the magnets of the magnet Halbach arrays 1104 through the heat pipes 1110 as shown illustratively as heat dissipation lines 1118 in FIG. 11.

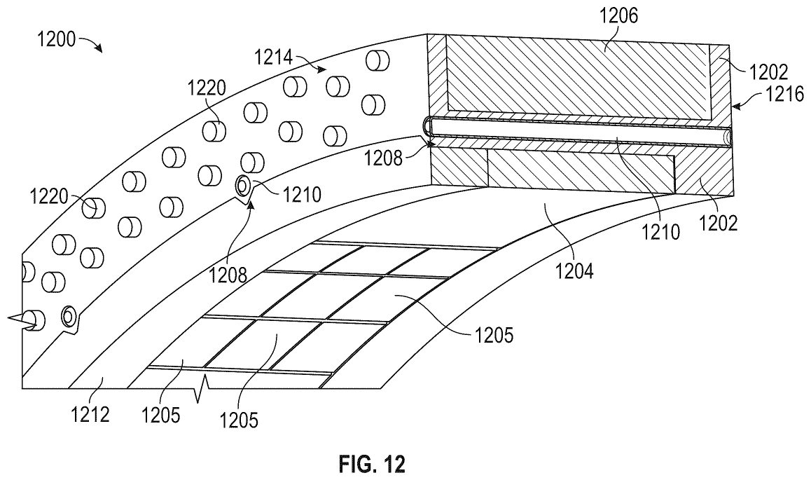

Referring now to FIG. 12, a schematic illustration of an outer rotor 1200 in accordance with another embodiment of the present disclosure is shown. The outer rotor 1200 may be arranged similar to that shown and described above. The outer rotor 1200 includes a magnet support 1202 configured to support a set of magnet Halbach arrays 1204 on an inner diameter surface and a rotor sleeve 1206 on an outer diameter surface thereof. A rotor end ring 1212 axially retains the magnet Halbach arrays 1204 on the magnet support 1202. The magnet support 1202 includes a set of protrusions 1208 that are configured to engage with a cut-out notch of the magnet Halbach arrays 1204. As shown in FIG. 12, for example, the magnet Halbach arrays 1204 may be formed from a set of magnets 1205 which may be arranged as segmented arrays that are segmented both axially and circumferentially. Such segmented configured can result in limited thermal conduction.

As such, the outer rotor 1200 includes a set of heat pipes 1210 installed within the material of the protrusions 1208. The protrusions 1208 may be seated within cut-out notches of the magnet Halbach arrays 1204. Heat from the magnets of the magnet Halbach arrays 1204 may be dissipated through the material of the magnet support 1202, the rotor end ring 1212, and the heat pipes 1210. To increase thermal dissipation from the outer rotor 1200 to the surrounding environment (e.g., moving air), end surfaces, such as on a forward end face 1214 and/or an aft end face 1216, of the magnet support 1202 may include optional thermal dissipation elements 1220. The thermal dissipation elements 1220 may be structures or features that are configured to increase a surface area of the respective end faces 1214, 1216, to increase the thermal transfer rate thereof. The thermal dissipation elements 1220 may be arranged as pins, fins, protrusions, and/or may be a surface texturing or surface roughness. The thermal dissipation elements 1220 are configured to increase the surface area at the interface between the magnet support 1202 and the surrounding environment. It will be appreciated that the thermal dissipation elements 1220 may be provided on surfaces of the rotor end ring 1212 and/or the aft end fact 1216.

As described above, the protrusions of the magnet supports may be configured to contain heat pipes to provide increased heat removal capabilities of the rotor assemblies. As described herein, the protrusions are arranged to seat within a cut-out notch of a magnet or magnet Halbach array, providing increased surface area of contact between the respective magnet surfaces and the surfaces of the protrusions, as compared to a non-notched configuration. This increased surface area can increase the amount of heat pick-up and heat removal provided by the heat pipes in the protrusions. The protrusions also provide an additional torque transfer during rotation of the respective rotors.

In accordance with embodiments of the present disclosure, the magnets may be permanent magnets to be assembled as motors with high power and torque density for aviation applications. The high torque density can be achieved by maximizing the magnetic loading through implementation of the Halbach array permanent magnet rotor structure and temperature control as described above. Typically, the dense permanent magnets can be a major barrier when minimizing the weight and thermal management of the application. However, embodiments of the present disclosure introduce Halbach array magnets with a notch cut-out that is configured to mate or engage with a protrusion of a magnet support that has integrated heat pipes within the protrusions. Such arrangement effectively reduces the weight of the magnets (e.g., removed material along notch cut-out), improving the power density (e.g., Halbach array configuration), and improving thermal management (e.g., integrated heat pipes). In accordance with some embodiments, it may be optimal to arranged the cut-out notch at or on a center magnet in the Halbach array. This magnet is not in the magnetic flux path, resulting in minimal impact on torque production and magnet weight reduction. The notch and protrusion engagement can serve as a locating feature during assembly process and the integrated heat pipes will improve heat rejection from the magnets thereby improving the efficiency of the motor.

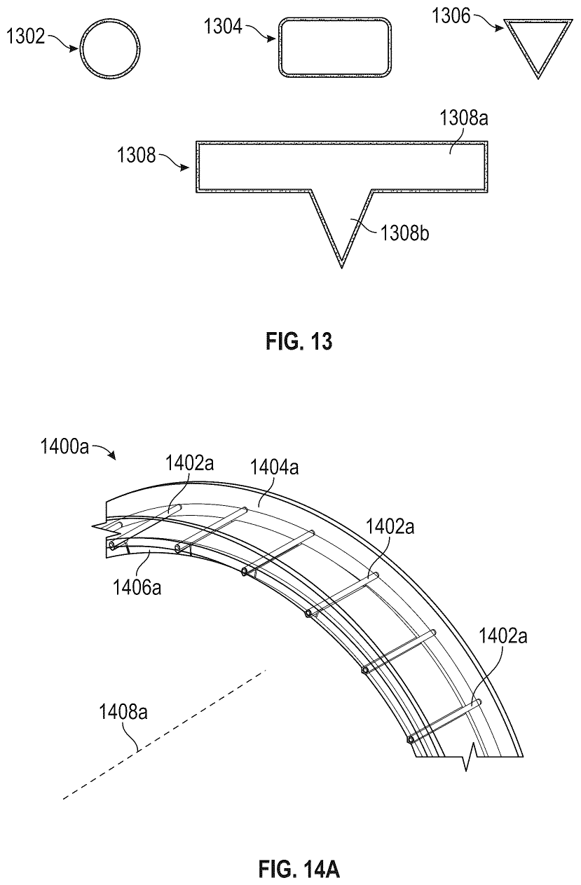

Referring now to FIG. 13, schematic illustrations of various heat pipe geometries that may be incorporated into the thermal management arrangements of electric motors of the present disclosure are shown. The heat pipes shown in FIG. 13 may be arranged to extend axially through a magnet support. In some embodiments, the heat pipes may be configured at an angle relative to axial, such as having a tangential or circumferential component such that they heat pipes are arranged at a skewed angle relative to an axis through the respective electric motor. As shown in FIG. 13, a first heat pipe geometry 1302 has a circular cross-sectional geometry. A second heat pipe geometry 1304 is illustrated as a squared or rectangular cross-section, which may have curved corners (as shown) or may be squared at the corners. A third heat pipe geometry 1306 is shown as triangular, which may optionally have curved corners. A fourth heat pipe geometry 1308 is shown having a unique or complex geometry. The fourth heat pipe geometry 1308 includes an axial span 1308a and a protruding element 1308b extending therefrom. In configurations that include the fourth heat pipe geometry 1308, the heat pipe may extend circumferentially across multiple magnets, and the protruding element 1308b may be seated within a cut-out notch formed in a set of magnets, similar to that shown and described above. In accordance with some embodiments, the cross-sectional geometry of the heat pipe may match have symmetry with the shape of the cut-out notch of the magnets.

In addition to having unique geometries, it will be appreciated that the heat pipes may be discrete elements installed within the magnet support, or may be integrally formed therewith. In the case of installed elements, the heat pipes may be inserted into the material of the magnet support, into a filler material, or may be seated between surfaces of the magnet support and surfaces of the magnets, with an optional binder or adhesive applied to the external surfaces of the heat pipes to secure the heat pipes to the magnet support structure. In the case of integrally formed heat pipes, the structure/material of the magnet support may be drilled, bored, or formed (e.g., machined, additively manufactured, molded, etc.) with holes that may be filled with phase-change material and then the holes may be capped.

Additionally, although illustratively shown above with the heat pipes being arranged axially within the magnet supports, such axial orientation or alignment is not intended to be limiting. For example, the heat pipes may be arranged at a skewed angle relative to an axis through the rotor of the electric motor. In the case of skewed heat pipes, the heat pipes would still be seated or arranged within or along protrusions that interface with notches of the magnet arrays. As such, in the skewed arrangement, the protrusions and the magnet arrays would also be arranged with a skew relative to the axis. In some embodiments, the heat pipes may be split, such that a forward and an aft heat pipe are arranged within a single protrusion. Furthermore, in some such embodiments, the split heat pipes may also be skewed or offset circumferentially. In still other embodiments, the heat pipes may include a radial angling component.

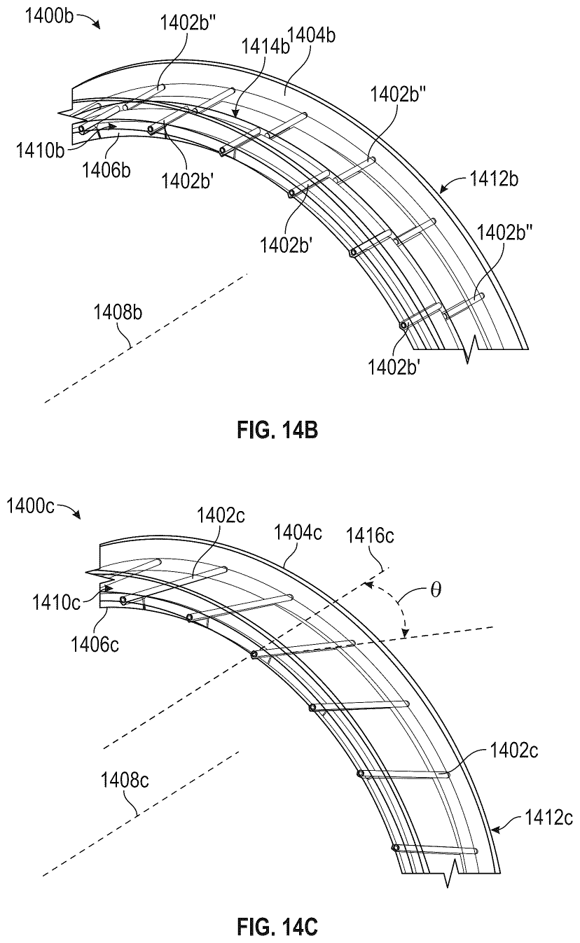

For example, with reference to FIGS. 14A-14C, schematic illustrations of rotor assemblies 1400a-c illustrating different arrangements of heat pipes 1402a-c in accordance with embodiments of the present disclosure are shown. The rotor assemblies 1400a-c may be similar in structure and arrangement as the systems and arrangements illustrated and described above, and various features are omitted for ease of discussion and illustration. The rotor assemblies 1400a-c may be arranged within or as part of aircraft electric motors or the like.

Rotor assembly 1400a, shown in FIG. 14A, includes a set of heat pipes 1402a arranged within a magnet support 1404a. The magnet support 1404a supports a set of magnets 1406a on an inner diameter thereof. The magnets 1406a may be magnet arrays, such as magnet Halbach arrays. The magnets 1406a may include cut-out notches on the side that engages with the magnet support 1404a, such as shown and described above. The heat pipes 1402a are arranged within, along, or are defined by protrusions of the magnet support 1404a, similar to that shown and described above. The magnet support 1404a is a hoop or ring structure arrange about a motor axis 1408a. In this configuration, the heat pipes 1402a are oriented parallel to the motor axis 1408a.

Rotor assembly 1400b, shown in FIG. 14B, includes a set of heat pipe sections 1402b′, 1402b″ arranged within a magnet support 1404b. The magnet support 1404b supports a set of magnets 1406b on an inner diameter thereof, such as magnet Halbach arrays. The magnets 1406b may include cut-out notches on the side that engages with the magnet support 1404b, such as shown and described above. The heat pipe sections 1402b′, 1402b″ are arranged within, along, or are defined by protrusions of the magnet support 1404b. The magnet support 1404b is a hoop or ring structure arrange about a motor axis 1408b. In this configuration, the heat pipe sections 1402b are oriented parallel to the motor axis 1408. In this embodiment, the heat pipe sections 1402b′, 1402b″ are partial axial length heat pipes. That is, the heat pipe sections 1402b′, 1402b″ may each extend from an end face inward toward an axially central location. For example, a forward heat pipe section 1402b′ extends from a forward end face 1410b toward an aft end face 1412b. An aft heat pipe 1402b″ extends from the aft end face 1412b toward the forward end face 1410b.

In this specific illustration, each of the forward and aft end heat pipe sections 1402b′, 1402b″ extend axially half-way across the axial length of the magnet support 1404b, to an axially central location 1414b. It will be appreciated that such equal length split heat pipe sections 1402b′, 1402b″ may extend different axial lengths from the respective end faces 1410b, 1412b, or even may not extend all the way to a respective end face 1410b, 1412b, but rather may be a completely encased heat pipe completely surrounded by material of the magnet support 1404b.

Also illustratively shown in FIG. 14B, the heat pipe sections 1402b′, 1402b″ may be circumferentially offset from each other. Stated another way, the heat pipe sections 1402b′, 1402b″ are stepped or staggered. Another way of described this configuration is to consider the heat pipe sections 1402b′, 1402b″ as partial segments that are offset circumferentially to form a form of skewed or incremental skew arrangement of the heat pipe sections 1402b′, 1402b″ about the circumference of the magnet support 1404b. In some such configurations, the two sections of the heat pipe sections 1402b′, 1402b″ may be fluidly connected by a section of heat pipe that extends circumferentially to connect the two heat pipe sections 1402b′, 1402b″.

Rotor assembly 1400c, shown in FIG. 14C, includes a set of heat pipes 1402c arranged within a magnet support 1404c. The magnet support 1404c supports a set of magnets 1406c on an inner diameter thereof, such as magnet Halbach arrays. The magnets 1406c may include cut-out notches on the side that engages with the magnet support 1404c, such as shown and described above. The heat pipes 1402c are arranged within, along, or are defined by protrusions of the magnet support 1404c, similar to that shown and described above. The magnet support 1404c is a hoop or ring structure arrange about a motor axis 1408c.

In this configuration, the heat pipes 1402c are oriented at an angle θ relative to a line 1416c parallel to the motor axis 1408c. The line 1416c is a line drawn parallel to the motor axis 1408c from a position or point of a given heat pipe 1402c on a forward end face 1410c to a point axially aft along the line 1416c on an aft end face 1412c. As such, with the heat pipes 1402c that extend, axially from the forward end face 1410c toward the aft end face 1412c, a forward position or point of a given heat pipe 1402c on the forward end face 1410c does not axially align with an aft end position or point of the given heat pipe 1402c on the aft end face 1412c, but rather is offset by the angle θ. In accordance with some embodiments, the angle θ of the skewed or angled heat pipes 1402c may be between 0° and 30°.

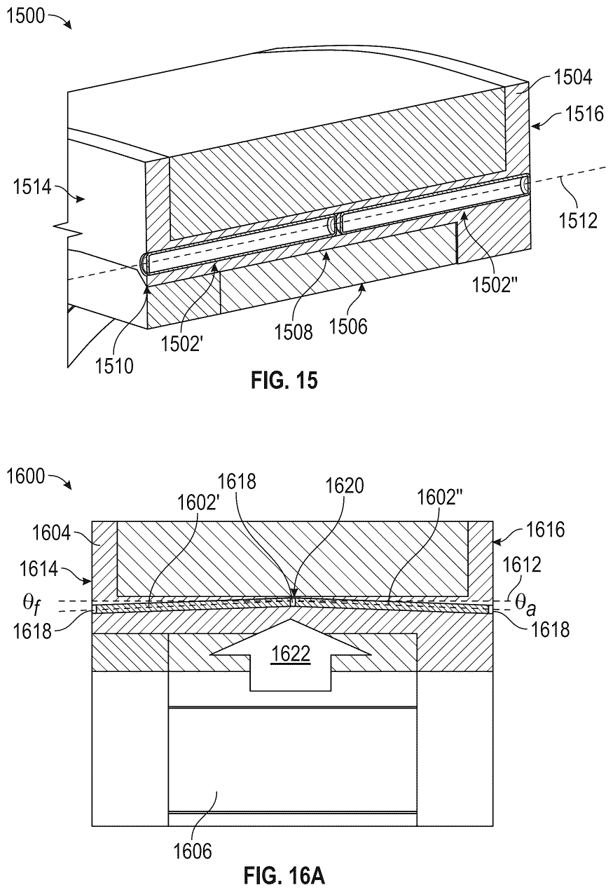

Referring now to FIG. 15, a schematic illustration of a rotor assembly 1500 in accordance with an embodiment of the present disclosure is shown. The rotor assembly 1500 includes a set of heat pipe sections 1502′, 1502″ arranged within a magnet support 1504. The magnet support 1504 supports a set of magnets 1506 on an inner diameter thereof, such as magnet Halbach arrays. The magnets 1506 may include cut-out notches 1508 on the side that engages with the magnet support 1504, such as shown and described above. The heat pipe sections 1502′, 1502″ are arranged within, along, or are defined by protrusions 1510 of the magnet support 1504, similar to that shown and described above. The magnet support 1504a is a hoop or ring structure arrange about a motor axis, and in this configuration, the heat pipe sections 1502′, 1502″ are oriented parallel to the motor axis along a central axis parallel line 1512.

In this illustrative configuration, the heat pipe sections 1502′, 1502″ are axially aligned sets with a forward heat pipe section 1502′ and an aft heat pipe section 1502″. The forward heat pipe section 1502′ extends from a forward end face 1514 toward an aft end face 1516. An aft heat pipe section 1502b″ is arranged end-to-end with the forward heat pipe section 1502′ and extends from the aft end face 1516 toward the forward end face 1514. In this configuration, each of the heat pipe sections 1502′, 1502″ is equal in axial length. In other embodiments, one of the two heat pipe sections 1502′, 1502″ may be axially longer than the other, and such other heat pipe 1502′, 1502″ would thus be axially shorter, such that the combined axial length of the heat pipe sections 1502′, 1502″ that are arranged end-to-end is equal to the axial length of the magnet support 1504. In still other embodiments, if the heat pipe sections 1502′, 1502″ are also arranged skew to the line 1512, then the lengths may be further adjusted, such that, for example, the total linear length of a given heat pipe or set of heat pipes may be greater than the axial length of the magnet support.

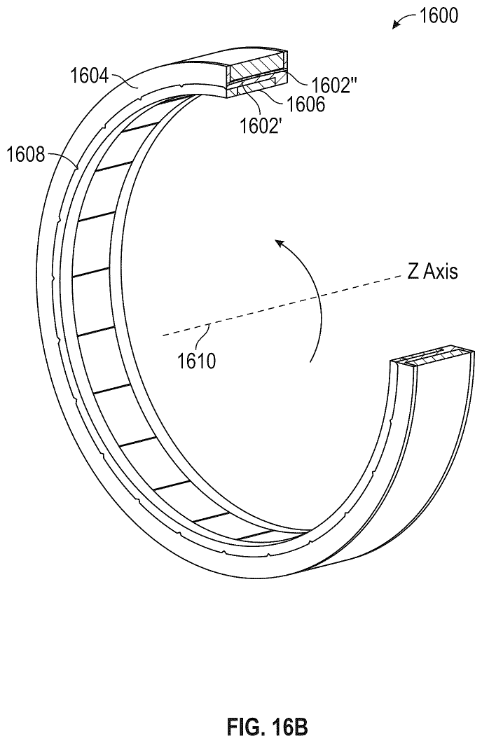

Referring now to FIGS. 16A-16B, schematic illustrations of a rotor assembly 1600 in accordance with an embodiment of the present disclosure are shown. The rotor assembly 1600 includes a set of heat pipe sections 1602′, 1602″ arranged within a magnet support 1604. The magnet support 1604 supports a set of magnets 1606 on an inner diameter thereof, such as magnet Halbach arrays. The magnets 1606 may include cut-out notches on the side that engages with the magnet support 1604, such as shown and described above. The heat pipe sections 1602′, 1602″ are arranged within, along, or are defined by protrusions 1608 of the magnet support 1604, similar to that shown and described above. The magnet support 1604 is a hoop or ring structure arrange about a motor axis 1610, and in this configuration, the heat pipe sections 1602′, 1602″ are oriented axially parallel to the motor axis 1610 along a central axis parallel line 1612.

In this illustrative configuration, the heat pipe sections 1602′, 1602″ are axially aligned sets with a forward heat pipe section 1602′ and an aft heat pipe section 1602″. The forward heat pipe section 1602′ extends from a forward end face 1614 toward an aft end face 1616. An aft heat pipe section 1602″ is arranged end-to-end with the forward heat pipe section 1602′ and extends from the aft end face 1616 toward the forward end face 1614. In this configuration, each of the heat pipe sections 1602′, 1602″ is radially angled. Additionally, in this illustrative configuration, rather than being separate elements installed into the magnet support 1604, the heat pipe sections 1602′, 1602″ are formed by bored or drilled or formed holes within the magnet support 1604. As such, the heat pipe sections 1602′, 1602″ are defined by one or more plugs 1618. During assembly, a central plug 1618 may be installed within the bore, such as at an inflection point 1620. In this illustration, the heat pipe sections 1602′, 1602″ are equal in axial length, and the inflection point 1620 is aligned with the axial center of the magnet support 1604. It will be appreciated that in other embodiments, the apex is not limited to being at the axial central location, but may be offset toward the forward end face 1614 or the aft end face 1616. With the central plug 1618 in place, the two bores of the heat pipe sections 1602′, 1602″ may be filled with a phase change material or the like, and then the ends of the heat pipe sections 1602′, 1602″ may be sealed with additional plugs 1618.

As noted above, the heat pipe sections 1602′, 1602″ are radially angled. In this configuration, the heat pipe sections 1602′, 1602″ are angled radially inward from the inflection point 1620. That is, the forward heat pipe section 1602′ extends axially forward from the inflection point 1620 (e.g., at the central plug 1618) to a point on the forward end face 1614 that is radially inward relative to the inflection point 1620. Similarly, the aft heat pipe section 1602″ extends axially aft from the inflection point 1620 (e.g., at the central plug 1618) to a point on the aft end face 1616 that is radially inward relative to the inflection point 1620. The angle at which the heat pipe sections 1602′, 1602″ are angled radially inward may be the same or different between the forward and aft heat pipe sections 1602′, 1602″. In this illustration, the forward heat pipe section 1602′ is angled radially inward at an angle θ_{f} and the aft heat pipe section 1602″ is angled radially inward at an angle θₐ, relative to the central axis parallel line 1612.

During operation, the inclusion of the radial angling of the heat pipe sections 1602′, 1602″ may enable improved cooling. For example, as the rotor assembly 1600 is rotated about the motor axis 1610, as illustrated in FIG. 16B, centrifugal pumping action 1622, shown in FIG. 16A, may cause a fluid pumping of the phase change material within the heat pipe sections 1602′, 1602″. For example, the angled heat pipe sections 1602′, 1602″ may be provided to enhance liquid phase material flow toward the center (e.g., inflection point 1620) and the vapor phase will be caused to flow toward the end faces 1614, 1616, thereby enhancing heat removal from the magnets 1606.

It will be appreciated that the various heat pipe geometries 1302-1308 shown FIG. 13 and the various heat pipe orientations shown in FIGS. 14A-14C, 15, and 16A-16B may be combined, interchanged, added to, or modified thereby, to have a cooling scheme to fit a desired application. The various geometries and orientations described herein may be used to provide highly tuned and efficient cooling to electric motors, thereby increasing efficiencies thereof. Additionally, the various arrangements and configurations described herein, and modifications thereof, may be used to optimize cooling of an electric motor which can enable use of different materials, such as lighter materials, thereby providing weight savings.

Advantageously, embodiments of the present disclosure provide for improved electric motors for aircraft and aviation applications. The aircraft electric motors of the present disclosure may provide for electric motors having reduced motor weight, increased efficiency, and increased manufacturability. Further, embodiments of the present disclosure may achieve such improvements while having negligible impact on torque production and increased power density. The cut-out notches of the rotors, as described herein, provide for the reduction in material of the magnets which in turn reduces the total weight of the system. Corresponding protrusions of the magnet supports that engage with the cut-out notches of the magnets provide for torque transfer surfaces and enable installation or arranging heat pipes in thermal communication with the magnets. The heat pipes can provide improved thermal management by removing heat from the center of the magnets/magnet arrays. Advantageously, by reducing the overall magnet temperature by inclusion of the heat pipes, lower temperature rated magnetic material may be used, such as reduction of use of heavy rare earth magnetic materials and/or increases in performance may be achieved by boosting the energy produced by the motors that incorporate such features as described herein.

The terms “about” and “substantially” are intended to include the degree of error associated with measurement of the particular quantity based upon the equipment available at the time of filing the application. For example, “about” or “substantially” can include a range of ±8% or 5%, or 2% of a given value. The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made, and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure is not limited to the particular embodiment disclosed as the best mode contemplated for carrying out this present disclosure, but that the present disclosure will include all embodiments falling within the scope of the claims.

What is claimed is:

1. An aircraft electric motor comprising:
a rotor assembly comprising a plurality of magnets arranged in magnet Halbach arrays on a magnet support, wherein the magnet support comprising a plurality of protrusions defined on surface thereof and each magnet Halbach array comprises a respective cut-out notch configured to engage with a respective protrusion;
an output shaft operably coupled to the rotor assembly;
a stator comprising a support structure and at least one winding wrapped about a plurality of stator teeth, the stator configured to generate an electromagnetic field to cause rotation of the rotor assembly; and
a heat pipe arranged within each protrusion of the plurality of protrusions, the heat pipe configured to transfer heat away from the magnets.

2. The aircraft electric motor of claim 1, wherein the notch is formed in at least one center magnet of each magnet Halbach array.

3. The aircraft electric motor of claim 1, wherein the notch is formed between two split-magnets at ends of adjacent magnet Halbach arrays.

4. The aircraft electric motor of claim 1, wherein each heat pipe comprises a forward heat pipe section and an aft heat pipe section arranged between a forward end face and an aft end face of the magnet support.

5. The aircraft electric motor of claim 4, wherein the forward heat pipe section is circumferentially offset from the aft heat pipe section.

6. The aircraft electric motor of claim 4, wherein the magnet support defines a forward end face and an aft end face and wherein the forward heat pipe section is angled radially inward in a direction from an inflection point between the forward end face and the aft end face to the forward end face and the aft heat pipe section is angled radially inward in a direction from the inflection point to the aft end face.

7. The aircraft electric motor of claim 1, further comprising a rotor wrap arranged about the magnet support and configured to structurally support the magnet support.

8. The aircraft electric motor of claim 1, wherein the rotor assembly comprises:
an outer rotor and an inner rotor, wherein the stator is arranged radially between the inner rotor and the outer rotor.

9. The aircraft electric motor of claim 8, wherein:
each of the inner rotor and the outer rotor comprise magnet Halbach arrays sets with cut-out notches, and
each of the inner rotor and the outer rotor comprise respective magnet supports having protrusions engaged with the cut-out notches.

10. The aircraft electric motor of claim 1, further comprising one or more thermal dissipation elements on an end face of the magnet support, the thermal dissipation elements configured to increase a surface area of the respective end face of the magnet support.

11. The aircraft electric motor of claim 10, wherein the one or more thermal dissipation elements comprise a plurality of pins, fins, and/or protrusions.

12. The aircraft electric motor of claim 10, wherein the one or more thermal dissipation elements comprise a surface texturing or surface roughness of the respective end face of the magnet support.

13. The aircraft electric motor of claim 1, wherein each heat pipe extends axially from a forward end face of the magnet support to an aft end face of the magnet support and is skewed at an angle relative to a motor axis defined by the rotor assembly.

14. The aircraft electric motor of claim 1, wherein each heat pipe is defined by a bore defined in the material of the magnet support that is filled with a phase-change material and plugged at at least one end of the respective heat pipe.

15. An aircraft comprising:
at least one aircraft electric motor;
at least one electrical device; and
a power distribution system configured to distribute power from the at least one electric motor to the at least one electrical device,
wherein the at least one aircraft electric motor comprises:
a rotor assembly comprising a plurality of magnets arranged in magnet Halbach arrays on a magnet support, wherein the magnet support comprising a plurality of protrusions defined on surface thereof and each magnet Halbach array comprises a respective cut-out notch configured to engage with a respective protrusion;
an output shaft operably coupled to the rotor assembly;
a stator comprising a support structure and at least one winding wrapped about a plurality of stator teeth, the stator configured to generate an electromagnetic field to cause rotation of the rotor assembly; and
a heat pipe arranged within each protrusion of the plurality of protrusions, the heat pipe configured to transfer heat away from the magnets.

16. The aircraft of claim 15, wherein the rotor assembly comprises:
an outer rotor and an inner rotor, wherein the stator is arranged radially between the inner rotor and the outer rotor.

17. The aircraft of claim 15, further comprising one or more thermal dissipation elements on an end face of the magnet support, the thermal dissipation elements configured to increase a surface area of the respective end face of the magnet support.

18. The aircraft of claim 15, wherein each heat pipe comprises a forward heat pipe section and an aft heat pipe section arranged between a forward end face and an aft end face of the magnet support.

19. The aircraft of claim 15, wherein each heat pipe extends axially from a forward end face of the magnet support to an aft end face of the magnet support and is skewed at an angle relative to a motor axis defined by the rotor assembly.

20. The aircraft of claim 15, wherein each heat pipe is defined by a bore defined in the material of the magnet support that is filled with a phase-change material and plugged at at least one end of the respective heat pipe.
